(19) United States
(12) Patent Application Publication
(10) Pub. No.: US 2026/0128660 A1
(43) Pub. Date: May 7, 2026

(54) ADAPTIVE POWER LIMITATION CIRCUIT AND HANDSHAKE DEACTIVATION/REACTIVATION PROTOCOL FOR A MULTIPHASE DCDC CONTROLLER

(71) Applicant: Allegro MicroSystems, LLC, Manchester, NH (US)

(72) Inventors: Marco Cignoli, Pavia (IT); Andrea Smaniotto, Albignasego (IT); Alessandro Bacceli, Bemareggio (IT)

(73) Assignee: Allegro MicroSystems, LLC, Manchester, NH (US)

(21) Appl. No.: 18/940,021

(22) Filed: Nov. 7, 2024

(51) Int. Cl. H02M 1/00; H02M 3/158

(52) U.S. Cl. CPC H02M 1/0043; H02M 3/1582

(57) ABSTRACT

A method pulls down, by a responder device having at least two responder channels, a first pin to a pre-determined voltage level when all responder channels of the responder device are turned OFF; detects that a requestor coupled to the responder has frozen a synchronization signal on a second pin when voltage on the first pin is below a certain threshold; terminates a pulling down, by the responder device, the first pin to the pre-determined voltage level after the responder device detects no activity on the second pin; generates a synchronization signal, by the requestor device, on a second pin when a load power demand reaches a reactivation threshold; and turns ON all responder channels of the responder device, by the responder device, when the responder device detects the synchronization signal on the second pin.

### BACKGROUND

DC/DC regulators operate by accepting an input DC voltage that may vary over a given range and output a constant DC voltage to provide a stable and reliable power supply. Fluctuations in power can lead to device malfunction or permanent circuit damage. DC/DC regulators ensure longevity and optimal functioning of many conventional electronic devices.

Conventional DC/DC regulators may operate in buck mode (convert an input DC voltage to a lower DC voltage of the same polarity), boost mode (convert an input DC voltage to a higher DC voltage of the same polarity), or buck-boost mode (convert an input DC voltage to a lower or higher DC voltage of the same polarity).

As power demands increase, single-phase converters reach their limitations in terms of current handling and efficiency. To counter these limitations, multiphase DCDC converters have been used to meet the increased power demands.

Conventional multiphase converters employ multiple converter circuits operating in parallel, sharing the load current. The use of conventional multiphase converters increases current capability by distributing the load current across multiple phases, thereby increasing the overall current handling capacity of the converter.

Moreover, the use of conventional multiphase converters reduces output ripple, wherein the phase-shifted operation of individual phases leads to a cancellation effect on the output ripple current, thereby having a cleaner and more stable output voltage and improving the performance of the powered devices.

Additionally, conventional multiphase converters achieve higher efficiency compared to conventional single-phase converters due to reduced losses associated with lower RMS currents and better thermal management. Also, conventional multiphase converters, by sharing the load, allow for smaller components in each phase and a more compact overall design.

On the other hand, conventional multiphase converters realize switching losses, wherein each phase in a multiphase converter has its own set of switching components, such as MOSFETs, which contribute to switching losses that become more prominent at low loads because the fixed losses are distributed over a smaller output power.

Also, conventional multiphase converters realize gate driver losses, wherein gate drivers, which are responsible for turning the MOSFETs ON and OFF, contribute to losses at light loads where the switching frequency remains constant while the output power decreases.

Moreover, conventional multiphase converters realize control circuit losses, wherein the circuitry responsible for controlling and synchronizing the phases consumes power that can become a significant portion of the total losses at low loads.

Several conventional mitigation techniques can be employed to improve the efficiency of multiphase converters at low output loads. One conventional technique is known as phase shedding, where one or more phases are disabled when the required output power falls below a certain threshold. By reducing the number of active phases, switching and gate driver losses can be minimized.

However, implementing this conventional technique introduces additional complexity and cost to the converter design due to additional control circuitry to manage the activation and deactivation of phases.

For example, implementing conventional phase shedding presents the challenge of generating power thresholds within the integrated circuit, instead of sensing the input and output voltage of the DCDC converter. The generation of power thresholds within the integrated circuit is topology dependent.

Another example of a challenge to implementing conventional phase shedding is the bi-directional communications between requestor and responder devices to achieve highest efficiency and dynamic performance on the regulated voltage.

### SUMMARY

According to an aspect of the disclosure, a device includes an adaptive power limitation circuit configured to automatically determine active phases of a DCDC converter based upon power level of the DCDC converter. The adaptive power limitation circuit includes a translinear circuit configured to convert the power level of the DCDC converter to a current level; and a clamping circuit, operatively connected to the translinear circuit, configured to clamp a maximum current of the adaptive power limitation circuit to a predetermined value.

According to another aspect of the disclosure, a system includes a DCDC converter; an adaptive power limitation circuit, operatively connected to the DCDC converter, configured to automatically determine active phases of the DCDC converter based upon power level of the DCDC converter; and a switch-mode controller, operatively connected to the DCDC converter and the adaptive power limitation circuit, configured to control a shedding of phases in the DCDC converter based upon a comparison between the generated current level and an inductor current of the DCDC converter. The adaptive power limitation circuit includes a translinear circuit and a clamping circuit operatively connected to the translinear circuit.

In other embodiments, the translinear circuit may include a plurality of switches configured to generate a reciprocal function. The translinear circuit may include a cascode configured to reduce an early effect of the plurality of switches. The translinear circuit may include an amplifier circuit configured to reduce the β effect of the plurality of switches.

In other embodiments, the adaptive power limitation circuit may include a mirror circuit operatively connected to the clamping circuit. An input signal conditioning circuit may be included, which is operatively connected to the translinear circuit, configured to sense a voltage of the DCDC converter.

In other embodiments, the current level generated by the adaptive power limitation circuit may be a function of a maximum power of the DCDC converter, the sensed voltage of the DCDC converter, and a current scaling factor.

In other embodiments, the input signal conditioning circuit may be configured to generate an input current to the translinear circuit, wherein the input current is a function of a maximum current acceptable by the adaptive power limitation circuit, the sensed voltage of the DCDC converter, and a maximum voltage of the DCDC converter.

The input signal conditioning circuit may be configured to sense an output voltage of the DCDC converter. The current level generated by the adaptive power limitation circuit may be a function of a maximum power of the DCDC converter, the sensed output voltage of the DCDC converter, and a current scaling factor.

In other embodiments, the input signal conditioning circuit may be configured to generate an input current to the translinear circuit, wherein the input current being a function of a maximum current acceptable by the adaptive power limitation circuit, the sensed output voltage of the DCDC converter, and a maximum output voltage of the DCDC converter.

In other embodiments, the input signal conditioning circuit may be configured to measure an input voltage of the DCDC converter. The current level generated by the adaptive power limitation circuit may be a function of a maximum power of the DCDC converter, the sensed output voltage of the DCDC converter, and a current scaling factor.

In other embodiments, the current level generated by the adaptive power limitation circuit may be a function of a maximum power of the DCDC converter, the sensed input voltage of the DCDC converter, and a current scaling factor.

In other embodiments, the DCDC converter may be a two-channel synchronous boost converter controller, a two-channel synchronous buck converter controller, a single channel synchronous boost converter controller, a single channel synchronous buck converter controller, a buck-boost controller, a multiphase boost converter controller, or a multiphase buck converter controller.

According to another aspect of the disclosure, a method for shedding one or more phases of a DCDC converter (a) senses a voltage of the DCDC converter; (b) senses an inductor current of the DCDC converter; (c) converts, using a reciprocal function, the sensed voltage of the DCDC converter to generate a current level; and (d) sheds a phase of the DCDC converter based upon a comparison of the generated current level and the sensed inductor current.

In other embodiments, the generated current level may be a function of a maximum power of the DCDC converter, the sensed voltage of the DCDC converter, and a current scaling factor. The sensed voltage of the DCDC converter may be an output voltage of the DCDC converter. The generated current level may be a function of a maximum power of the DCDC converter, the sensed output voltage of the DCDC converter, and a current scaling factor. The sensed voltage of the DCDC converter may be an input voltage of the DCDC converter. The generated current level may be a function of the maximum power of the DCDC converter, the sensed input voltage of the DCDC converter, and a current scaling factor.

According to another aspect of the disclosure, a method (a) pulls down, by a responder device having at least two responder channels, a first pin to a pre-determined voltage level when all responder channels of the responder device are turned OFF; (b) detects that a requestor device coupled to the responder device has frozen a synchronization signal on a second pin when voltage on the first pin is below a certain threshold; and (c) terminates a pulling down, by the responder device, the first pin to the pre-determined voltage level after the responder device detects no activity on the second pin.

In other embodiments, the method may turn OFF, by the responder device, a responder channel when a requested load power is below a deactivation threshold. The method may turn OFF a synchronization signal, by the requestor device, on the second pin when voltage on the first pin is below a short-to-ground threshold. The method may pull down, by the responder device, the first pin to a pre-determined voltage level when a responder channels is turned OFF for a first predetermined period of time. The method may turn OFF the clock signal, by the requestor device, on the second pin when voltage on the first pin is below a certain threshold for a second predetermined period of time. The method may turn OFF, by the responder device, responder channels of the responder device, one by one in a pre-determined sequence at a pre-determined time interval, when a requested load power is below a deactivation threshold. The method may terminate the pulling down, by the responder device, of the first pin to the pre-determined voltage level after the responder device detects no activity on the second pin for a third predetermined period of time.

The method may pull down, by the responder device, the first pin to a pre-determined voltage level when a second responder channel of the responder device is turned OFF. The method may pull down, by the responder device, the first pin to a pre-determined voltage level when a second responder channel of the responder device is turned OFF for a first predetermined period of time.

In other embodiments, the first pin may be a pin for sharing a compensation voltage and the second pin may be a pin to synchronize other device operation with a clock signal. The responder device may be included in a multiphase boost converter controller or a multiphase buck converter controller.

According to another aspect of the disclosure, a method (a) detects on a first pin, by a responder device, a synchronization signal generated by a requestor device, when a load power demand reaches a reactivation threshold; and (b) turns ON all responder channels, by the responder device, when the responder device detects the synchronization signal on the first pin.

According to another aspect of the disclosure, a method (a) generates a synchronization signal, by a requestor device, on a first pin when a load power demand reaches a reactivation threshold; and (b) turns ON all responder channels, by a responder device, when the responder device detects the synchronization signal on the first pin.

In other embodiments, the requestor device generates the synchronization signal on a first pin when the load power demand reaches the reactivation threshold after a first predetermined period of time. The method may turn ON all responder channels, by the responder device, when the responder device detects the synchronization signal on the first pin after a second predetermined period of time. The generated synchronization signal may be synchronous with a main switching clock signal of the requestor device. The generated synchronization signal may be shifted by a predetermined amount from the main switching clock signal of the requestor device. The first pin may be a pin to synchronize other device operation with a clock signal. The responder device may be included in a multiphase boost converter controller or a multiphase buck converter controller.

According to another aspect of the disclosure, a method (a) pulls down, by a responder device having at least two responder channels, a first pin to a pre-determined voltage level when all responder channels are turned OFF; (b) detects that a requestor device coupled to the responder device has frozen a synchronization signal on a second pin when voltage on the first pin is below a certain threshold; (c) terminates a pulling down, by the responder device, the first pin to the pre-determined voltage level after the responder device detects no activity on the second pin; (d) generates a synchronization signal, by the requestor device, on a second pin when a load power demand reaches a reactivation threshold; and (e) turns ON all responder channels, by the responder device, when the responder device detects the synchronization signal on the second pin.

In other embodiments, the method may turn OFF, by the responder device, responder channels when a requested load power is below a deactivation threshold. The method may turn OFF a synchronization signal, by the requestor device, on the second pin when voltage on the first pin is below a certain threshold. The method may pull down, by the responder device, a first pin to a pre-determined voltage level when all responder channels are turned OFF for a first predetermined period of time. The method may turn OFF, by the responder device, responder channels of the responder device, one by one in a pre-determined sequence at a pre-determined time interval, when a requested load power is below a deactivation threshold. The method may turn OFF the synchronization signal, by the requestor device, on a second pin when voltage on the first pin is below a certain threshold for a second predetermined period of time. The method may terminate a pulling down, by the responder device, the first pin to the pre-determined voltage level after the responder device detects no activity on the second pin for a third predetermined period of time.

In other embodiments, the method may generate a synchronization signal, by the requestor device, on a second pin when a load power demand reaches a reactivation threshold after a fourth predetermined period of time. The method may turn ON all responder channels, by the responder device, when the responder device detects the synchronization signal on the second pin after a fifth predetermined period of time.

In other embodiments, the generated synchronization signal may be synchronous with a main switching clock signal of the requestor device. The generated synchronization signal may be shifted by a predetermined amount from the main switching clock signal of the requestor device. The first pin may be a pin for sharing a compensation voltage and the second pin may be a pin to synchronize other device operation with a clock signal.

According to another aspect of the disclosure, a method (a) pulls down, by a responder device, a first pin to a pre-determined voltage level when all responder channels of the responder device are turned OFF; (b) detects that a requestor coupled to the responder has frozen a synchronization signal on a second pin when voltage on the first pin is below a certain threshold; (c) terminates a pulling down, by the responder device, the first pin to the pre-determined voltage level after the responder device detects no activity on the second pin; (d) generates a synchronization signal, by the requestor device, on a second pin when a load power demand reaches a reactivation threshold; and (e) turns ON all responder channels of the responder device, by the responder device, when the responder device detects the synchronization signal on the second pin.

In other embodiments, the method may turn OFF, by the responder device, all responder channels when a requested load power is below a deactivation threshold. The method may turn OFF a synchronization signal, by the requestor device, on the second pin when voltage on the first pin is below a certain threshold. The method may turn OFF, by the responder device, the responder channels of the responder device, one by one in a pre-determined sequence at a pre-determined time interval, when a requested load power is below a deactivation threshold. The method may pull down, by the responder device, a first pin to a pre-determined voltage level when all responder channels of the responder device are turned OFF for a first predetermined period of time. The method may turn OFF the synchronization signal, by the requestor device, on a second pin when voltage on the first pin is below a certain threshold for a second predetermined period of time.

In other embodiments, the method may terminate a pulling down, by the responder device, the first pin to the pre-determined voltage level after the responder device detects no activity on the second pin for a third predetermined period of time. The method may generate a clock signal, by the requestor device, on a second pin when a load power demand reaches a reactivation threshold after a fourth predetermined period of time. The method may turn ON all responder channels, by the responder device, when the responder device detects the clock signal on the second pin after a fifth predetermined period of time.

In other embodiments, the generated synchronization signal may be synchronous with a main switching clock signal of the requestor device. The generated synchronization signal may be shifted by a predetermined amount from a main switching clock signal of the requestor device. The method first pin may be a pin for sharing a compensation voltage and the second pin may be a pin to synchronize other device operation with a clock signal.

According to another aspect of the disclosure, a system includes a requestor device having a requestor second pin and a requestor first pin; a responder device having a responder second pin and a responder first pin; the requestor second pin being connected to the responder second pin; the requestor first pin being connected to the responder first pin; the requestor first pin being configured to buffer compensation voltage of a channel of the requestor device with the responder device; the requestor second pin being configured to synchronize switching activity between the requestor device and the responder device.

In other embodiments, the requestor device may be a first integrated circuit package and the responder device is a second integrated circuit package. The first pin may be a pin for sharing a compensation voltage and the second pin may be a pin to synchronize other device operation with a clock signal. The requestor device and the responder device may be included in a multiphase boost converter controller or a multiphase buck converter controller.

### BRIEF DESCRIPTION OF THE DRAWINGS

The drawings are only for purposes of illustrating various embodiments and are not to be construed as limiting, wherein:

FIG. 1 illustrates a buck-boost converter;

FIG. 2 illustrates a topology of a half-bridge configured for buck mode;

FIG. 3 illustrates a topology of a half-bridge configured for boost mode;

FIG. 4 illustrates a topology of two half-bridges configured for buck-boost mode;

FIG. 5 illustrates a buck multiphase DCDC converter;

FIG. 6 illustrates a boost multiphase DCDC converter;

FIG. 7 illustrates a multiphase DCDC converter system using an adaptive power limitation circuit;

FIG. 8 illustrates an example of a squaring/reciprocal translinear circuit;

FIG. 9 illustrates an example of an adaptive power limitation circuit with a signal input circuit;

FIG. 10 illustrates an adaptive power limitation circuit using a reciprocal function translinear circuit;

FIG. 11 illustrates a graphical characteristic of an adaptive power limitation circuit;

FIG. 12 illustrates an example of a pin-out for a 4 phases boost converter controller for use with a phase shedding handshake protocol;

FIG. 13 illustrates a graphical characteristic of a deactivation protocol; and

FIG. 14 illustrates a graphical characteristic of a reactivation protocol.

### DETAILED DESCRIPTION OF THE DRAWINGS

In the following description and claims, the terms, requestor device and responder device, have been used. The term, requestor device, refers to a device that is a component in a system which is responsible of the management of the main functionality of the system. The term, responder device, refers to a device which receives instructions from a requestor device.

In other words, the requestor device is responsible for controlling, through generated control signals, the multiphase operations, such as managing voltage/current loops, buffering synchronization signal and compensation voltage, etc., to which the responder device follows the generated control signals. The requestor device orchestrates the interactions between itself and one or more responder devices, ensuring that data is sent correctly. Moreover, as described in more detail below, the responder device is responsible for starting a handshake protocol, pulling down the first pin, and releasing the first pin as acknowledgement of a stop in a synchronization operation of the requestor device.

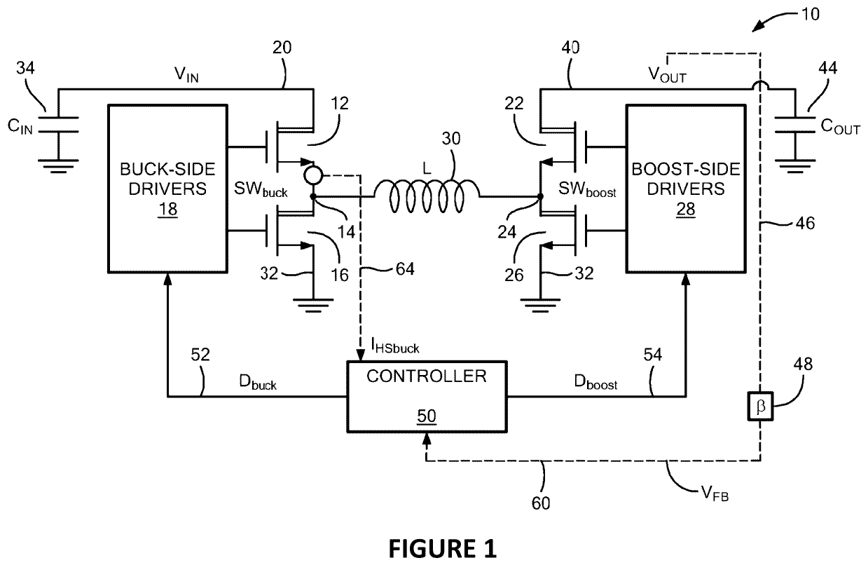

FIG. 1 illustrates a buck-boost converter 10 having a high side buck switch 12 coupled to a low side buck switch 16 at a first switch node SW_{buck} 14 and a high side boost switch 22 coupled to a low side boost switch 26 at a second switch node SW_{boost} 24. The buck-boost converter 10 is configured to have an inductor 30 coupled between the first switch node 14 and the second switch node 24. The buck switches 12, 16 are coupled between an input voltage source V_{IN} 20 and a ground reference potential 32. An input capacitor 34 can be coupled to the input voltage source 20. The boost switches 22, 26 are coupled between the converter output at which a regulated output voltage V_{OUT} 40 is provided and ground 32. An output capacitor 44 can be coupled to the converter output 40.

Controller 50 is configured to generate control signals for both the buck side switches 12, 16 and also for the boost side switches 22, 26. Buck-side drivers 18 are coupled to receive a control signal D_{buck} 52 from controller 50 and to generate control signals for buck switches 12, 16. Similarly, boost-side drivers 28 are coupled to receive a control signal D_{boost} 54 from controller 50 and to generate control signal for boost switches 22, 26.

Controller 50 is coupled to receive a feedback voltage VFB 60 and a current sense signal I_{HSbuck} 64. The current sense signal 64 is indicative of a current IL, through the inductor 30. In this embodiment, the current sense signal 64 is indicative of a current through the high side buck switch 12 when the switch is ON and thus, this sensed inductor current can be represented as I_{HSbuck}. However, it will be appreciated by those of ordinary skill in the art that other schemes for sensing the inductor current IL are possible.

The feedback voltage 60 is based on the converter output voltage 40 and may be level-shifted by an element 48 to a reference voltage level, for example on the order of 1.0V. Various schemes are possible for implementing element 48, such as a resistive partition and, optionally, a feedforward capacitor to introduce a phase boost, for example.

Controller 50 can implement current mode control based on the current sense signal 64 and can include a robust single voltage control loop based on the feedback signal 60.

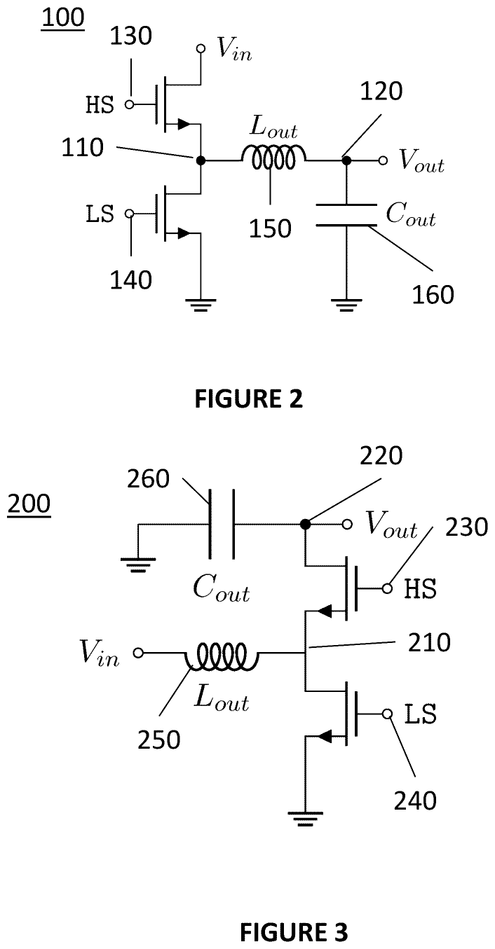

FIG. 2 illustrates a topology of a half-bridge configured for buck mode. As illustrated in FIG. 2, a half-bridge 100 includes a high side switch HS coupled to a low side switch LS at a first node 110. An inductor 150 coupled between the first node 110 and a second node 120. The second node 120 is coupled to a capacitor 160. The high side switch HS and the low side switch LS are coupled between an input voltage source V_{IN} and a ground reference potential. An input capacitor can be coupled to the input voltage source V_{IN}.

FIG. 3 illustrates a topology of a half-bridge configured for boost mode. As illustrated in FIG. 3, a half-bridge 200 includes a high side switch HS coupled to a low side switch LS at a first node 210. An inductor 250 coupled between the first switch node 210 and an input voltage source V_{IN}. A second node 220 can be coupled to a capacitor 260. The high side switch HS and the low side switch LS are coupled between an output voltage source V_{OUT} and a ground reference potential.

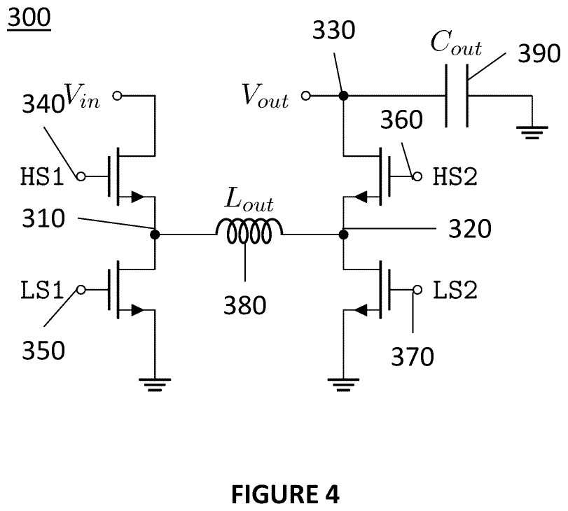

FIG. 4 illustrates a topology of two half-bridges configured for buck-boost mode. As illustrated in FIG. 4, two half-bridges 300 include a high side switch HS1 coupled to a low side switch LS1 at a first node 310 and a high side switch HS2 coupled to a low side switch LS2 at a second node 320. An inductor 380 is coupled between the first node 310 and a second node 320. A third node 330 is coupled to a capacitor 390. The high side switch HS1 and the low side switch LS1 are coupled between an input voltage source V_{IN} and a ground reference potential. An input capacitor can be coupled to the input voltage source.

The gate 340 of the high side switch HS1 is coupled to an output node of a first pulse-width modulator based signal generator (not shown). The gate 350 of the low side switch LS1 is coupled to an output node of the first pulse-width modulator based signal generator.

A third node 330 can be coupled to a capacitor 390. The high side switch HS2 and the low side switch LS2 are coupled between an output voltage source V_{OUT} and a ground reference potential.

The gate 360 of the high side switch HS2 is coupled to an output node of a second pulse-width modulator based signal generator (not shown). The gate 370 of the low side switch LS2 is coupled to an output node of the second pulse-width modulator based signal generator.

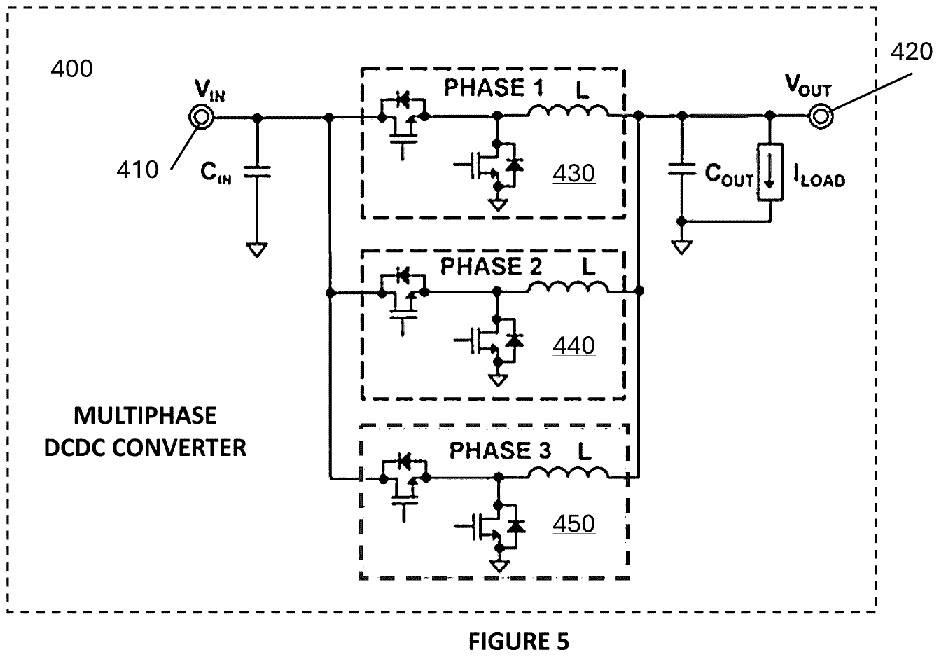

FIG. 5 illustrates an example of a buck multiphase DCDC converter that can be utilized with an adaptive power limitation circuit. As illustrated in FIG. 5, a buck multiphase DCDC converter 400 includes a voltage input 410, which is operatively connected to phase circuits (430, 440, & 450) configured in a buck mode. The phase circuits (430, 440, & 450) are connected in parallel. The parallel phase circuits (430, 440, & 450) are operatively connected to a voltage output 420. The buck configured phase circuits (430, 440, & 450) can be turned ON independently in response to an increased demand for power. The buck configured phase circuits (430, 440, & 450) can also be turned OFF independently, in response to a decreased demand for power, to realize phase shedding.

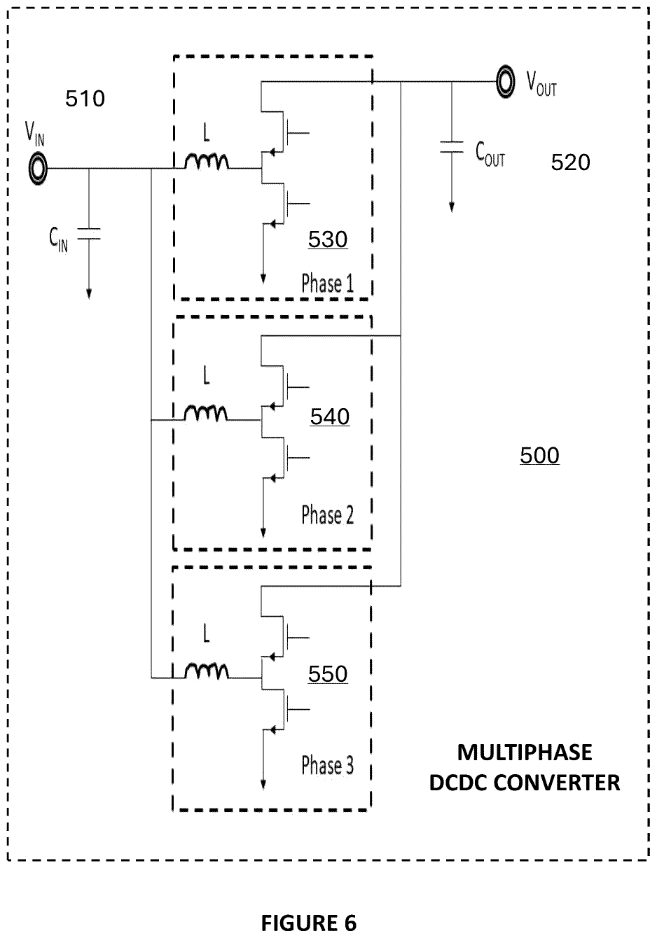

FIG. 6 illustrates an example of a boost multiphase DCDC converter that can be utilized with an adaptive power limitation circuit. As illustrated in FIG. 6, a boost multiphase DCDC converter 500 includes a voltage input 510, which is operatively connected to phase circuits (530, 540, & 550) configured in a boost mode. The phase circuits (530, 540, & 550) are connected in parallel. The parallel phase circuits (530, 540, & 550) are operatively connected to a voltage output 520. The boost configured phase circuits (530, 540, & 550) can be turned ON independently in response to an increased demand for power. The boost configured phase circuits (530, 540, & 550) can also be turned OFF independently, in response to a decreased demand for power, to realize phase shedding.

Although FIGS. 5 and 6 illustrate examples of two multiphase DCDC converters that can be used with an adaptive power limitation circuit, the adaptive power limitation circuit can be utilized with a two-channel synchronous boost converter controller, a two-channel synchronous buck converter controller, a single channel synchronous boost converter controller, a single channel synchronous buck converter controller, or a buck-boost controller.

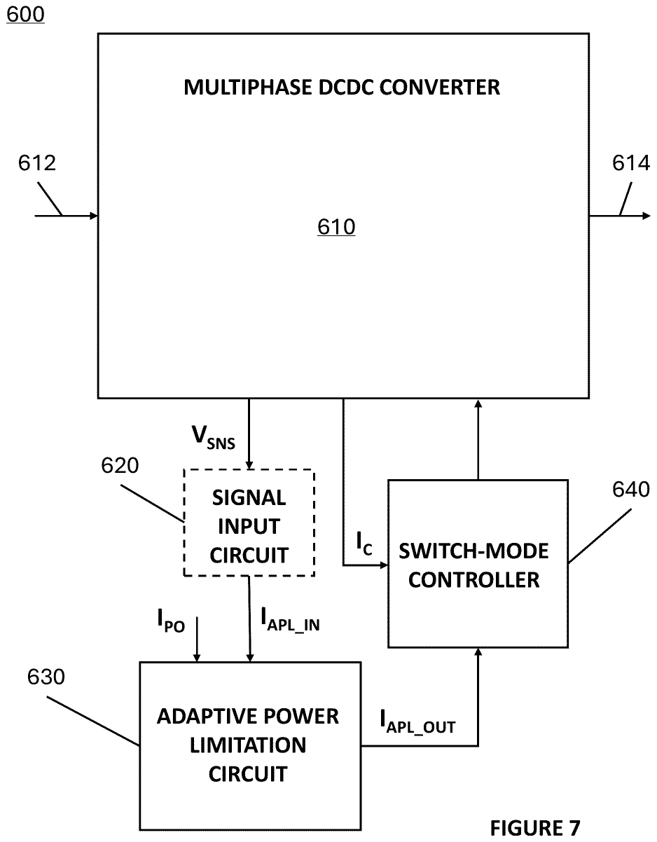

FIG. 7 illustrates a multiphase DCDC converter system using an adaptive power limitation circuit. As illustrated in FIG. 7, a multiphase DCDC converter system 600 includes a multiphase DCDC converter 610 having an input voltage 612 and an output voltage 614. The multiphase DCDC converter 610 is operatively connected to a signal input circuit 620 which converts sensed voltage signals from the multiphase DCDC converter 610 to current signals (I_{APL_IN}) that can be utilized by adaptive power limitation circuit 630 to generate dynamically adaptive current thresholds (I_{APL_OUT}). The generated dynamically adaptive current thresholds (I_{APL_OUT}) are fed to a switching mode controller 640, which compares the inductor current (I_{C}) of the multiphase DCDC converter 610 with the generated dynamically adaptive current thresholds (I_{APL_OUT}) to control the phase shedding.

In other words, the multiphase DCDC converter system 600 converts power thresholds into current thresholds by sensing the input or output voltage of the multiphase DCDC converter system 600. The current thresholds adapt dynamically based on the input or output voltage of the multiphase DCDC converter system 600, effectively tracking a constant power curve. By comparing the inductor current of the multiphase DCDC converter system 600, using a shunt resistor (not shown), with these dynamically adaptive current thresholds (I_{APL_OUT}), a controller can implement appropriate phase shedding

It is noted that the multiphase DCDC converter system 600 can be implemented in a single integrated circuit or on multiple chips.

It is further noted that upon generation of the dynamically adaptive current thresholds (I_{APL_OUT}), these thresholds can be utilized in adaptive current limitation inside the current control loop of the DCDC converter, adaptive anti-windup on the output of the error amplifier, etc.

The adaptive power limitation circuit is used to automatically decide the active phases of the multiphase DCDC converter based on the output power level of the multiphase DCDC converter. The adaptive power limitation circuit generates a current limitation based on the maximum input or output power level P_{SNS}_{_{MAX}}, considered as constant value and trimmable in function of the application maximum power level target, and the sensed input or output voltage V_{SNS}(t). Depending on the DCDC converter configuration, the V_{SNS}(t) can be considered the input or the output voltage of the DCDC converter because it is desired to limit the inductor current. Thus, the measurement is related to where the inductor is placed in the DCDC converter.

For example, in a buck configuration, the inductor is placed on the output stage, so its average current is equal to the load current. The measured output voltage is used to generate a current limitation, defined as:

$${I}_{{O}_{LIM}} ( t ) = \frac{{P}_{{O}_{MAX}}}{{V}_{O} ( t )} .$$

Additionally, for example, in a boost configuration, the inductor is placed on the input stage, so its average current is equal to the battery current. The measured input voltage is used to generate a current limitation, defined as:

$${I}_{{IN}_{LIM}} ( t ) = \frac{{P}_{{IN}_{MAX}}}{{V}_{IN} ( t )} = \frac{1}{η} \cdot \frac{{P}_{{O}_{MAX}}}{{V}_{IN} ( t )} .$$

The adaptive power limitation circuit uses an input current proportional to the sensed voltage and to implement the following function:

$${I}_{APL\_OUT} ( t ) = \frac{{P}_{{SNS}_{MAX}}}{{V}_{SNS} ( t )} \cdot \frac{1}{{K}_{SNS}}$$

where K_{SNS} is the current sense scaling factor defined as the ratio of the inductor current and the analog scaled current used to close a current loop in a current mode controller. Since the input time variant variable is in the denominator, a circuit capable of generating a reciprocal function is needed.

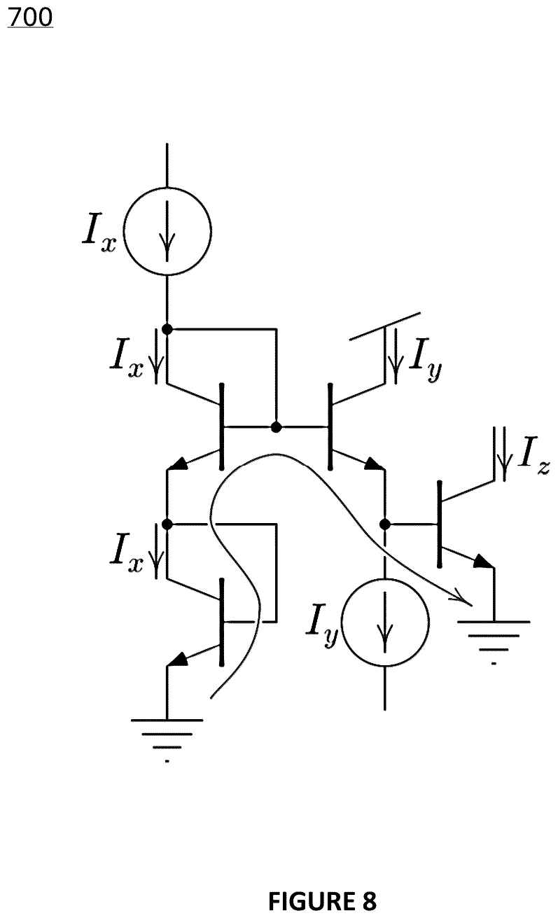

The reciprocal function of the adaptive power limitation circuit can be implemented using a translinear circuit, as illustrated in FIG. 8. With respect to FIG. 8, the translinear circuit uses I_{Y} as the input variable and I_{X} as an input constant to derive the reciprocal function as:

$${I}_{z} ( t ) = \frac{{I}_{x}^{2}}{{I}_{y} ( t )} .$$

The adaptive power limitation circuit current equation can be written in the same form of the reciprocal function described above:

$${I}_{APL\_OUT} ( t ) = \frac{{P}_{{SNS}_{MAX}}}{{V}_{SNS} ( t )} \cdot \frac{1}{{K}_{SNS}} = \frac{{P}_{{SNS}_{MAX}}}{{V}_{SNS} ( t )} \cdot \frac{1}{{K}_{SNS}} \cdot \frac{\frac{{I}_{{APL\_IN}_{MAX}}}{{V}_{{SNS}_{MAX}}}}{\frac{{I}_{{APL\_IN}_{MAX}}}{{V}_{{SNS}_{MAX}}}} = \frac{{I}_{{APL\_IN}_{MAX}}}{{I}_{APL\_IN} ( t )} \cdot ( \frac{{P}_{{SNS}_{MAX}}}{{V}_{{SNS}_{MAX}}} \cdot \frac{1}{{K}_{SNS}} ) = \frac{{I}_{PO}^{2}}{{I}_{APL\_IN} ( t )}$$

$$where :$$

$$\{ \begin{matrix}{I}_{APL\_IN} ( t ) = {V}_{SNS} ( t ) \cdot \frac{{I}_{{APL\_IN}_{MAX}}}{{V}_{{SNS}_{MAX}}} \\ {I}_{PO}^{2} = {I}_{{APL\_IN}_{MAX}} \cdot ( \frac{{P}_{{SNS}_{MAX}}}{{V}_{{SNS}_{MAX}}} \cdot \frac{1}{{K}_{SNS}} )\end{matrix}$$

and I_{APL_IN}_{_{MAX}} is the maximum input current acceptable by the adaptive power limitation circuit and V_{SNS}_{_{MAX}} is the maximum sensed voltage.

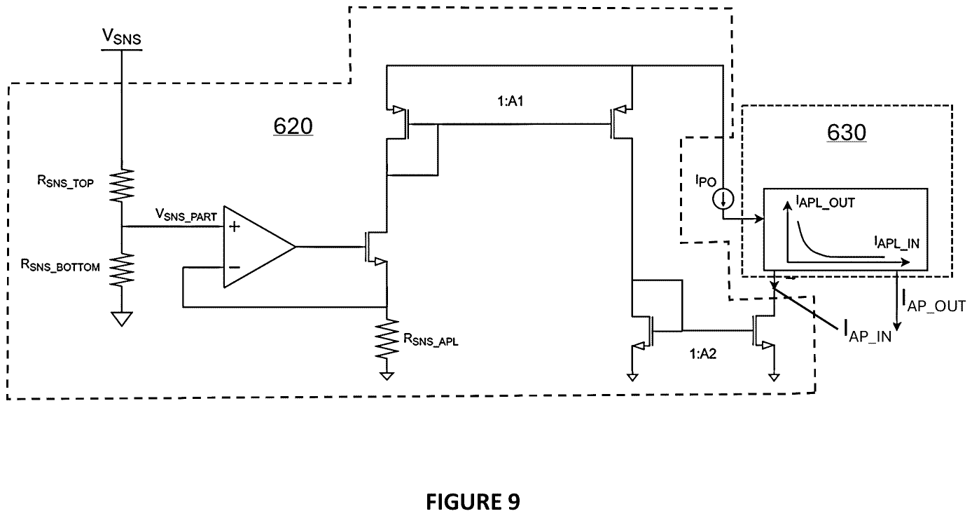

FIG. 9 illustrates an example of an adaptive power limitation circuit with a signal input circuit. As illustrated in FIG. 9, an adaptive power limitation circuit 630 is operatively connected to a signal input circuit 620, which generates the input current I_{APL_IN} for the adaptive power limitation circuit 630, based upon the sensed voltage V_{SNS} of the DCDC converter (not shown).

With respect to the circuitry illustrated in FIG. 9, the input current I_{APL_IN} (t) can be written as:

$${I}_{APL\_IN} ( t ) = {V}_{SNS} ( t ) \cdot \frac{{I}_{{APL\_IN}_{MAX}}}{{V}_{{SNS}_{MAX}}} = {V}_{SNS} ( t ) \cdot \frac{{R}_{{SNS}_{BOTTOM}}}{{R}_{{SNS}_{TOP}} + {R}_{{SNS}_{BOTTOM}}} \cdot \frac{{A}_{1} {A}_{2}}{{R}_{SNS\_APL}} .$$

Additionally, with respect to the circuitry illustrated in FIG. 9, current I_{PO} can be derived as:

$${I}_{PO} = \sqrt{{I}_{{APL\_IN}_{M A X}} \cdot ( \frac{{P}_{{SNS}_{MAX}}}{{V}_{{SNS}_{MAX}}} \cdot \frac{1}{{K}_{SNS}} ) .}$$

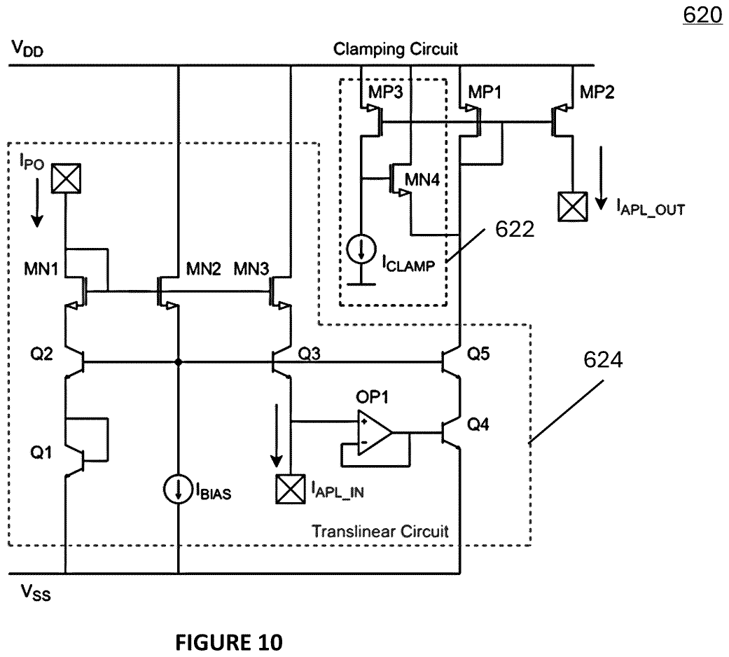

FIG. 10 illustrates an adaptive power limitation circuit using a reciprocal function translinear circuit. As illustrated in FIG. 10, the adaptive power limitation circuit 620 includes a translinear circuit 624 and a clamping circuit 622.

As configured in FIG. 10, the translinear circuit 624 produces the reciprocal function, as described above. Transistors Q1, Q2, Q3, and Q4 provide the reciprocal function. MN1, MN3 and Q5 form a cascode to reduce the early effect of the core transistors, while MN2 and OP1 reduce the β effect of the transistors Q1, Q2, Q3, and Q4.

Moreover, as configured in FIG. 10, the clamping circuit 622 clamps the maximum output current of the adaptive power limitation circuit 620 to a predefined value. This clamping prevents the function from having an ideal maximum at +∞ when I_{APL_IN}=0. MP3 is used to mirror a scaled replica of I_{APL_OUT} and compare it with I_{CLAMP}. In the case where the scaled replica of I_{APL_OUT} is higher than I_{CLAMP}, MN4 will carry the additional current so that I_{APL_OUT} remains constantly clamped to its maximum value.

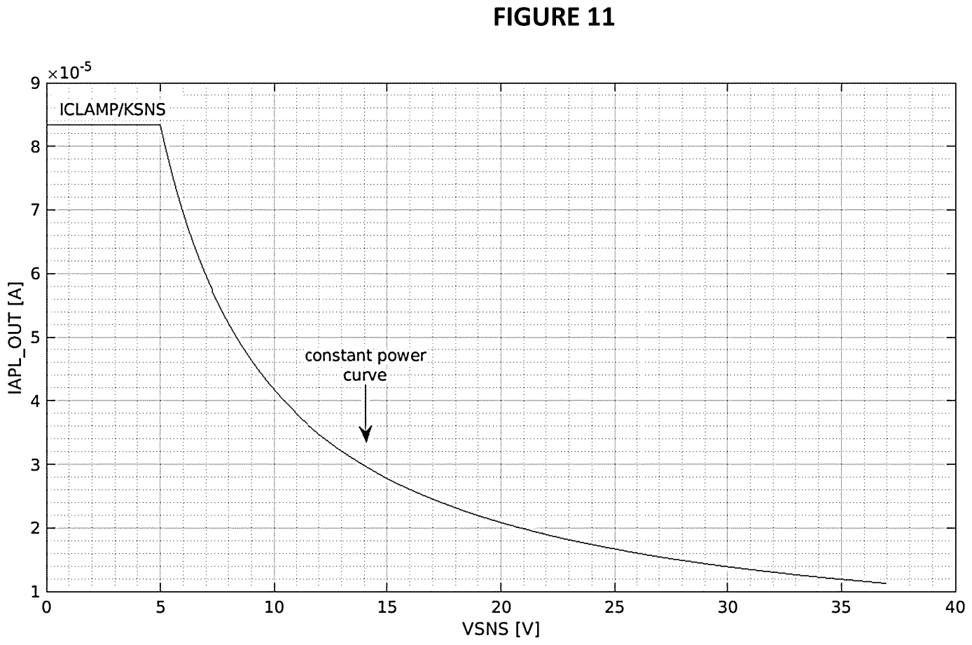

FIG. 11 illustrates a graphical characteristic of an adaptive power limitation circuit. As illustrated in FIG. 11, the graphical characteristic of an adaptive power limitation circuit is based upon K_{SNS}=240 kA/A, P_{SNS}_{_{MAX}}=100 W and I_{CLAMP}=20 A.

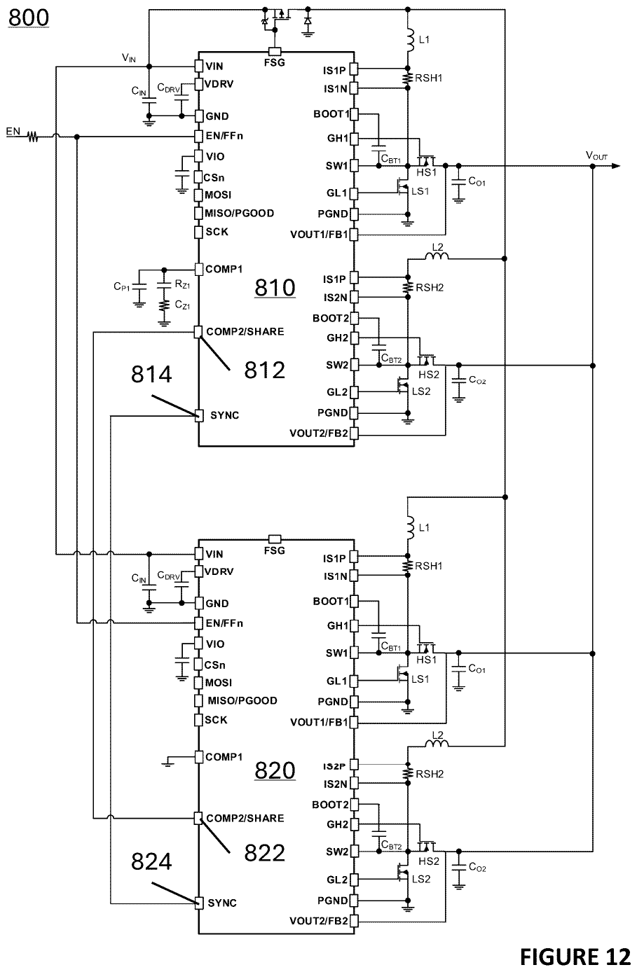

FIG. 12 illustrates an example of a pin-out for a 4 phases boost converter controller for use with a phase shedding handshake protocol. As illustrated in FIG. 12, the 4 phases boost converter controller 800 includes a first dual phase boost converter IC 810 and a second dual phase boost converter IC 820. Pin 812 of first dual phase boost converter IC 810, for sharing a compensation voltage, is connected to pin 822 of second dual phase boost converter IC 820, for sharing a compensation voltage. Moreover, Pin 814 of first dual phase boost converter IC 810, for synchronizing other device operation with a synchronization signal, is connected to pin 824 of second dual phase boost converter IC 820, for synchronizing other device operation with a synchronization signal.

The pins (812 and 822) (SHARE pins) buffer and share the compensation voltage of the first channel of the requestor device (the requestor device is generally in charge of handling the voltage loop) with the responder device. The responder device uses this information to close the current loop of each channel.

The pins (814 and 824) (SYNC pins) synchronize the switching activity between the requestor and the responder device. The requestor may use a different approach to generate the synchronization; e.g., synchronous with the main switching clock, shifted by an . . . ).

The configuration of FIG. 12 provides a solution to resource-constrained systems having limited I/O pins. The two pins (812 and 822) are shared (shorted together) between requestor and responder devices in an inter-chip multiphase configuration to share compensation voltage to responder phases. The two pins (814 and 824) are shared (shorted together) between requestor and responder devices in an inter-chip multiphase configuration to define phase shift between each phase.

The pin sharing topology, as illustrated in FIG. 12, by taking advantage of phase shedding operations, allows for more compact systems, reduces the need for dedicated pins, reduces the need for additional external circuitries to detect responder deactivations and to manage the inter-chip communications, and/or enables synchronization of requestor and responder devices in a multiphase configuration in a DCDC converter.

When the dynamic power management of the phases is needed, the requestor and responder devices communicate to each other the state of their channels to synchronize the activity. Any channel can independently understand when it needs to turn ON/OFF based on the power level, but additional information about the overall system is needed.

In addition to utilizing the above described pin sharing topology, communication of the state of the channels between requestor and responder devices, utilizing a handshake protocol on the shared pins (SHARE and SYNC), provides efficient and reliable control of responder devices by a requestor device, enabling deactivation, acknowledgement of deactivation, and reactivation, all through the use of the shared pins.

The handshake protocol can be divided into deactivation and reactivation.

The deactivation protocol relates to responder to requestor information flow; the information to be passed for the deactivation of all the responder phases; and usage such as when the load is sufficiently light, and the responder contribution is not needed.

The reactivation protocol relates to requestor to responder information flow; the information to be passed for the reactivation of all the available phases (phases that are supposed to be in sleep mode); and usage such as when there is a positive load regulation (the load increases quickly), and all the available phases must be active to support the quick load increase.

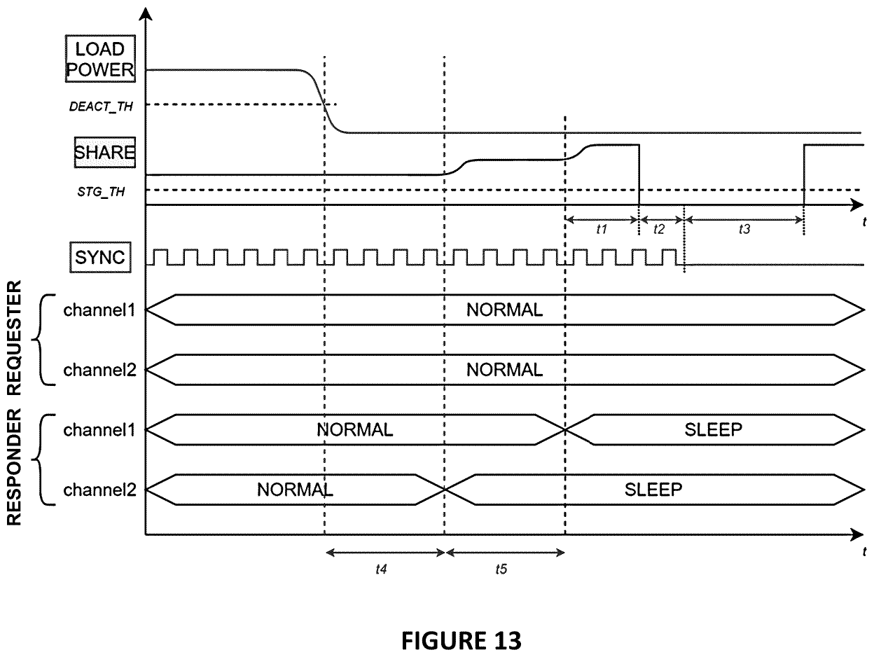

FIG. 13 illustrates a graphical characteristic of a deactivation protocol. As illustrated in FIG. 13, the deactivation protocol over the shared pins (SHARE & SYNC) calls for, when power requested by the load decreases below a deactivation threshold (“DEACT_TH”), the responder device starts to turn OFF the phases (channels) one by one. The responder device may follow a priority sequence and well-defined filter times “t₄”=“t₅” when turning OFF the phases (channels) one by one.

When all the responder channels are in sleep mode, the deactivation protocol calls for the responder device to pull down the SHARE pin to start a handshake communication with the requestor device. Alternatively, the responder device may, after all the responder channels are in sleep mode and after a time “t₁”, pull down the SHARE pin to start a handshake communication with the requestor device. It is noted that the loss of information on the SHARE pin does not impact the active channels on the requestor side since the active channels on the requestor side are referred to a copy of the SHARE that is internally protected (the SHARE is a buffered version of the internal compensation voltage).

When the voltage on the SHARE pin falls below the certain threshold (“STG_TH”), the deactivation protocol calls for the requestor device to freeze the synchronization signal on the SYNC pin. Alternatively, the requestor device may, when the voltage on the SHARE pin falls below the certain threshold (“STG_TH”) and after a filter time “t₂”, freeze the synchronization signal on the SYNC pin.

After the responder detects no activity on the SYNC pin, the deactivation protocol calls for the responder device to stop forcing the SHARE pin to ground. The SHARE pin can then return to the value defined by requestor device. Alternatively, after a filter time “t₃” and the responder detects no activity on the SYNC pin, the responder device stops forcing the SHARE pin to ground.

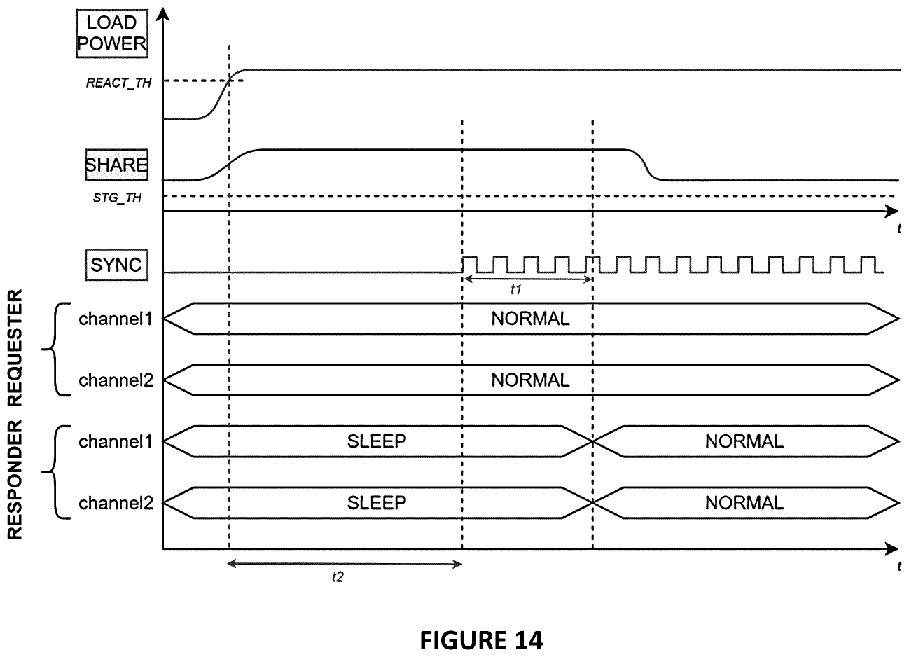

FIG. 14 illustrates a graphical characteristic of a reactivation protocol. As illustrated in FIG. 14, the reactivation protocol over the shared pins (SHARE & SYNC) calls for, when an increase of the load power happens, the DCDC control loop to react to its new inputs (load current and output voltage level), and the pin SHARE reach its maximum voltage level to indicate a power increase.

Once the load power demand surpasses the reactivation threshold (“REACT_TH”), the reactivation protocol calls for the requestor device to resume synchronization generation on the SYNC pin. Alternatively, the requestor device, after a filter time “t₂”, resumes synchronization generation on the SYNC pin.

When the responder detects activity on the SYNC pin, using a clock monitor, indicating that the requestor device wants to wake all the sleeping channels to sustain the increasing load, the reactivation protocol calls for the responder device to wake all the channels. Alternatively, after a filter time “t₁” and the responder detects activity on the SYNC pin, using a clock monitor, indicating that the requestor device wants to wake all the sleeping channels to sustain the increasing load, the responder device wakes all the channels.

Although the above description discusses the use of a clock monitor to detect activity on the SYNC pin, the activity on the SYNC pin can be detected by an edge detector or other detection device.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above and the following claims.

1. A method, comprising:
(a) pulling down, by a responder device having at least two responder channels, a first pin to a pre-determined voltage level when a responder channel of the responder device is turned OFF;
(b) detecting that a requestor device coupled to the responder device has frozen a synchronization signal on a second pin when voltage on the first pin is below a certain threshold; and
(c) terminating a pulling down, by the responder device, of the first pin to the pre-determined voltage level after the responder device detects no activity on the second pin.

2. The method according to claim 1, further comprising:
(d) turning OFF, by the responder device, a responder channel when a requested load power is below a deactivation threshold.

3. The method according to claim 1, further comprising:
(d) turning OFF a synchronization signal, by the requestor device, on the second pin when voltage on the first pin is below a certain threshold.

4. The method according to claim 1, wherein said (a) pulling down, by the responder device, the first pin to a pre-determined voltage level when the responder channel of the responder device is turned OFF for a first predetermined period of time.

5. The method according to claim 3, wherein said (d) turning OFF the synchronization signal, by the requestor device, on second the second pin when voltage on the first pin is below a certain threshold for a second predetermined period of time.

6. The method as claimed in claim 4, wherein said (d) turning OFF, by the responder device, responder channels of the responder device, one by one in a pre-determined sequence at a pre-determined time interval, when a requested load power is below a deactivation threshold.

7. The method according to claim 1, wherein said (c) terminating the pulling down, by the responder device, of the first pin to the pre-determined voltage level after the responder device detects no activity on the second pin for a first predetermined period of time.

8. The method according to claim 4, wherein said (c) terminating the pulling down, by the responder device, of the first pin to the pre-determined voltage level after the responder device detects no activity on the second pin for a second predetermined period of time.

9. The method according to claim 1, wherein the first pin is a pin for sharing a compensation voltage and the second pin is a pin to synchronize other device operation with a clock signal.

10. The method according to claim 1, wherein the responder device is included in a multiphase boost converter controller.

11. The method according to claim 1, wherein the responder device is included in a multiphase buck converter controller.

12. The method according to claim 1, wherein said (a) pulling down, by a responder device having at least two responder channels, a first pin to a pre-determined voltage level when all responder channels of the responder device are turned OFF.

13. The method according to claim 12, further comprising:
(d) turning OFF, by the responder device, all the responder channels of the responder device when a requested load power is below a deactivation threshold.

14. The method as claimed in claim 13, wherein said (d) turning OFF, by the responder device, the responder channels of the responder device, one by one in a pre-determined sequence at a pre-determined time interval, when a requested load power is below a deactivation threshold.

15. The method according to claim 10, wherein said (a) pulling down, by the responder device, the first pin to a pre-determined voltage level when all the responder channels of the responder device are turned OFF for a first predetermined period of time.

16. A method, comprising:
(a) detecting on a first pin, by a responder device, a synchronization signal generated by a requestor device, when a load power demand reaches a reactivation threshold; and
(b) turning ON a responder channel, by the responder device, when the responder device detects the synchronization signal on the first pin.

17. The method according to claim 16, wherein the requestor device generates the synchronization signal on a first pin when the load power demand reaches the reactivation threshold after a first predetermined period of time.

18. The method according to claim 16, wherein said (b) turning ON a responder channel, by the responder device, when the responder device detects the synchronization signal on the first pin after a first predetermined period of time.

19. The method according to claim 17, wherein said (b) turning ON a responder channel, by the responder device, when the responder device detects the synchronization signal on the first pin after a second predetermined period of time.

20. The method according to claim 16, wherein the generated synchronization signal is synchronous with a main switching clock signal of the requestor device.

21. The method according to claim 16, wherein the generated synchronization signal is shifted by a predetermined amount from a main switching clock signal of the requestor device.

22. The method according to claim 16, wherein the first pin is a pin to synchronize other device operation with a clock signal.

23. The method according to claim 16, wherein the responder device is included in a multiphase boost converter controller.

24. The method according to claim 16, wherein the responder device is included in a multiphase buck converter controller.

25. The method according to claim 16, wherein said (b) turning ON all responder channels, by a responder device, when the responder device detects the synchronization signal on the first pin.

26. The method according to claim 25, wherein said (b) turning ON all responder channels, by the responder device, when the responder device detects the synchronization signal on the first pin after a predetermined period of time.

27. A method, comprising:
(a) pulling down, by a responder device having at least two responder channels, a first pin to a pre-determined voltage level when a responder channel is turned OFF;
(b) detecting that a requestor device coupled to the responder device has frozen a synchronization signal on a second pin when voltage on the first pin is below a certain threshold;
(c) terminating a pulling down, by the responder device, the first pin to the pre-determined voltage level after the responder device detects no activity on the second pin;
(d) generating a synchronization signal, by the requestor device, on a second pin when a load power demand reaches a reactivation threshold; and
(e) turning ON a responder channel, by the responder device, when the responder device detects the synchronization signal on the second pin.

28. The method according to claim 27, further comprising:
(f) turning OFF, by the responder device, a responder channel when a requested load power is below a deactivation threshold.

29. The method according to claim 27, further comprising:
(f) turning OFF a synchronization signal, by the requestor device, on the second pin when voltage on the first pin is below a certain threshold.

30. The method according to claim 27, wherein said (a) pulling down, by the responder device, a first pin to a pre-determined voltage level when a responder channel is turned OFF for a first predetermined period of time.

31. The method as claimed in claim 30, wherein said (d) turning OFF, by the responder device, responder channels of the responder device, one by one in a pre-determined sequence at a pre-determined time interval, when a requested load power is below a deactivation threshold.

32. The method according to claim 29, wherein said (f) turning OFF the synchronization signal, by the requestor device, on a second pin when voltage on the first pin is below a certain threshold for a first predetermined period of time.

33. The method according to claim 27, wherein said (c) terminating a pulling down, by the responder device, the first pin to the pre-determined voltage level after the responder device detects no activity on the second pin for a first predetermined period of time.

34. The method according to claim 27, wherein said (d) generating a synchronization signal, by the requestor device, on a second pin when a load power demand reaches a reactivation threshold after a first predetermined period of time.

35. The method according to claim 27, wherein said (b) turning ON a responder channel, by the responder device, when the responder device detects the synchronization signal on the second pin after a first predetermined period of time.

36. The method according to claim 27, wherein the generated synchronization signal is synchronous with a main switching clock signal of the requestor device.

37. The method according to claim 27, wherein the generated synchronization signal is shifted by a predetermined amount from a main switching clock signal of the requestor device.

38. The method according to claim 27, wherein the first pin is a pin for sharing a compensation voltage and the second pin is a pin to synchronize other device operation with a clock signal.

39. The method according to claim 27, wherein the responder device is included in a multiphase boost converter controller.

40. The method according to claim 27, wherein the responder device is included in a multiphase buck converter controller.

41. The method according to claim 27, wherein said (a) pulling down, by a responder device having at least two responder channels, a first pin to a pre-determined voltage level when all responder channels of the responder device are turned OFF; and said (e) turning ON all responder channels of the responder device, by the responder device, when the responder device detects the synchronization signal on the second pin.

42. The method according to claim 41, further comprising:
(f) turning OFF, by the responder device, all responder channels when a requested load power is below a deactivation threshold.

43. The method according to claim 41, wherein said (a) pulling down, by the responder device, a first pin to a pre-determined voltage level when all responder channels of the responder device are turned OFF for a first predetermined period of time.

44. The method according to claim 41, wherein said (b) turning ON all responder channels, by the responder device, when the responder device detects the synchronization signal on the second pin after a first predetermined period of time.

45. A system comprising:
a requestor device having a requestor second pin and a requestor first pin;
a responder device having a responder second pin and a responder first pin;
said requestor second pin being connected to said responder second pin;
said requestor first pin being connected to said responder first pin;
said requestor first pin being configured to buffer and first compensation voltage of a channel of said requestor device with said responder device;
said requestor second pin being configured to synchronize switching activity between said requestor device and said responder device.

46. The system as claimed in claim 45, wherein said requestor device is a first integrated circuit package and said responder device is a second integrated circuit package.

47. The system according to claim 45, wherein the first pin is a pin for sharing a compensation voltage and the second pin is a pin to synchronize other device operation with a clock signal.

48. The system according to claim 45, wherein the requestor device and the responder device are included in a multiphase boost converter controller.

49. The system according to claim 45, wherein the requestor device and the responder device are included in a multiphase buck converter controller.
